(19) United States
(12) Patent Application Publication
(10) Pub. No.: US 2016/0357280 A1
(43) Pub. Date: Dec. 8, 2016

(54) METHOD AND APPARATUS TO IMPLEMENT TWO FINGER ROTATE GESTURE UTILIZING SELF-CAPACITANCE SENSING ON A TOUCHSCREEN

(71) Applicant: UICO, LLC, Elmhurst, IL (US)

(72) Inventors: Bahar Wadia, Bartlett, IL (US); Corey Wilner, Buffalo Grove, IL (US)

(21) Appl. No.: 14/731,051

(22) Filed: Jun. 4, 2015

(51) Int. Cl. G06F 3/044; G06F 3/0488; G06F 3/0484; G06F 3/041; G06F 3/01

(52) U.S. Cl. CPC G06F 3/044; G06F 3/0412; G06F 3/0416; G06F 3/017; G06F 3/04845; G06F 3/0488; G06F 2203/04104; G06F 2203/04112; G06F 2203/04808

(57) ABSTRACT

An apparatus that includes a self-capacitance touch screen, a capacitive sensing module and a touch detection module is disclosed. The self-capacitance touch screen comprises a set of row electrodes and a set of column electrodes. The capacitive sensing module is electrically coupled with the self-capacitance touch screen. The touch detection module electrically coupled with the capacitive sensing module. The touch detection module is configured to determine from scan data received from the capacitive sensing module respective spatial locations of a first touch and a substantially simultaneous second touch of the self-capacitance touch screen.

### TECHNICAL FIELD

This application relates generally to locating the position of a touch of a touch-screen. More specifically, this application relates to localizing the position of substantially simultaneous multiple touches of a self-capacitance touch screen and tracking the location of the touches while performing gestures such as a two-finger rotation gesture.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, is neither expressly nor impliedly admitted as prior art against the present disclosure.

Touch sensitive surfaces like touch-screen displays have helped fuel the rapid growth in the market for touch-enabled portable devices like global positioning system (GPS) receivers, smart phones, tablet computers and many other devices. Touch sensitive surfaces are finding new applications in devices where a user's touch interaction may be useful or convenient for interacting with the device. However, drawbacks in the conventional methods of detecting location of a touch have limited adoption of cheaper and larger touch screens.

### SUMMARY

Methods, apparatuses and systems are disclosed herein for locating the position of a touch of a touch-screen. In general, locating position of a touch involves determining that one or more touches has occurred and determining the physical locations of the one or more touches on the touch-screen. The physical locations may be expressed as or translated to or communicated as electrical signals or data for subsequent processing. Locating position of a touch of the touch-screen is one step in managing user interaction with a device which incorporates the touch-screen.

In accordance with one embodiment, a method for determining a location of a first touch and a location of a second touch of a self-capacitance touch sensor is disclosed. The self-capacitance touch sensor includes a first set of electrodes and a second set of electrodes. The first set of electrodes is substantially perpendicular to the second set of electrodes. Each of the first set of electrodes and each of the second set of electrodes has a respective length, a respective proximal end and a respective distal end. The method may include receiving from a capacitive sensing module coupled to the self-capacitance touch sensor a first set of values. Each value of the first set of values corresponds to a respective electrode of the first and second set and a respective magnitude of the value is proportional to the capacitance presented by the respective electrode. Each electrode is further characterized by a respective baseline capacitance. The method further may further include determining, based on the respective magnitudes of values of the first set of values, that the self-capacitance touch sensor was touched by a first touch and second touch and further determining a respective identity of a first and second electrode from the first set of electrodes and a respective identity of a first and second electrode from the second set of electrodes. In response to determining that the self-capacitance touch screen was touched by a first touch and second touch, a configuration of the capacitive sensing module is updated and the capacitive sensing module is instructed to measure the respective capacitances presented by the identified first electrode and second electrode of the first set of electrodes. The method may further include receiving from the capacitive sensing module a second set of data, wherein the magnitude of respective data of the second set of data is proportional to the respective capacitance presented by the identified first electrode and second electrode of the first set and wherein the magnitude of the data corresponding to the first electrode is proportional to the distance of the first touch from the proximal or the distal end of the first electrode and the magnitude of the data corresponding to second electrode is proportional to the distance of the second touch from the proximal or the distal end of the second electrode. The method may include identifying the first electrode of the second set based on the magnitude of the data corresponding to the first electrode and, based on the magnitude of the data corresponding to the second electrode, identifying the second electrode of the second set. The method may further include determining that the location of the first touch is proximal to the intersection of the first electrode of the first set and the first electrode of the second set and that the location of the second touch is proximal to the intersection of the second electrode of the first set and the second electrode of the second set.

### BRIEF DESCRIPTION OF THE DRAWINGS

FIG. 1 is a block diagram of an exemplary touch-enabled device.

FIG. 2 is an illustration of a system comprising a touch controller and a self-capacitance touch sensor that may be included in touch-enabled device of FIG.

FIG. 3 illustrates an exemplary multi-touch of a self-capacitance touch sensor of the system depicted in FIG. 2.

FIG. 4 is a graphical representation of the position-dependent sensitivity of an example electrode of the self-capacitance touch sensor.

FIG. 5 is a block diagram of an example touch sensor controller that may implement methods to localize the position of a touch of a self-capacitance touch sensor.

FIG. 6 illustrates an exemplary single touch of a self-capacitance touch sensor of the system depicted in FIG. 2.

FIG. 7 illustrates an exemplary multi-touch of a self-capacitance touch sensor of the system depicted in FIG. 2.

FIG. 8 is a flow diagram illustrating an example method that may be implemented by the touch sensor controller of FIG. 2 to localize the position of a first touch and a second touch of self-capacitance touch sensor.

FIG. 9 illustrates data stored in scan buffers that contain values corresponding to capacitance presented by the row and column electrodes of a self-capacitance sensor when a touch sensor controller is configured to operate in uniform-sensitivity mode.

FIG. 10 is a flow diagram illustrating an exemplary method that may be implemented to track a rotate gesture.

FIG. 11 illustrates the discrete steps of FIG. 10 of performing a multi-touch clockwise rotate gesture on the surface of a self-capacitance sensor.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different form. Therefore, covered or claimed subject matter is intended to be construed as not being limited to any example embodiments set forth herein. Example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

Methods and apparatuses that locate the approximate position(s) of a single touch and a multi touch of a surface of a touch sensitive surface are disclosed. Also disclosed are methods that detect and track gestures traced by moving fingers while the fingers are contacting the touch sensitive surface. Touch sensitive surfaces and more specifically, self-capacitance touch sensitive surfaces, generally exhibit uniform sensitivity. This means that irrespective of the location of a touch of the touch sensitive surface, a magnitude of the output response of the touch sensitive surface in response to the touch is approximately the same. Therefore, locating the position of a touch of the touch sensitive surface requires the solution of two simultaneous equations. Additionally, because of this uniform sensitivity it is not possible to locate the position of two approximately simultaneous touches of the touch sensitive surface.

In preferred exemplary embodiments described herein, improvements to methods implemented in apparatuses connected to the touch sensitive surface cause the touch sensitive surface to exhibit non-uniform or position dependent sensitivity. This means that a magnitude of the output response varies based on the location of a touch of the touch-sensitive surface. By a priori characterization of the variation of the magnitude of the output response based on the location of the touch, methods described herein may locate the position of a touch based on the magnitude of the output response of the touch-sensitive surface.

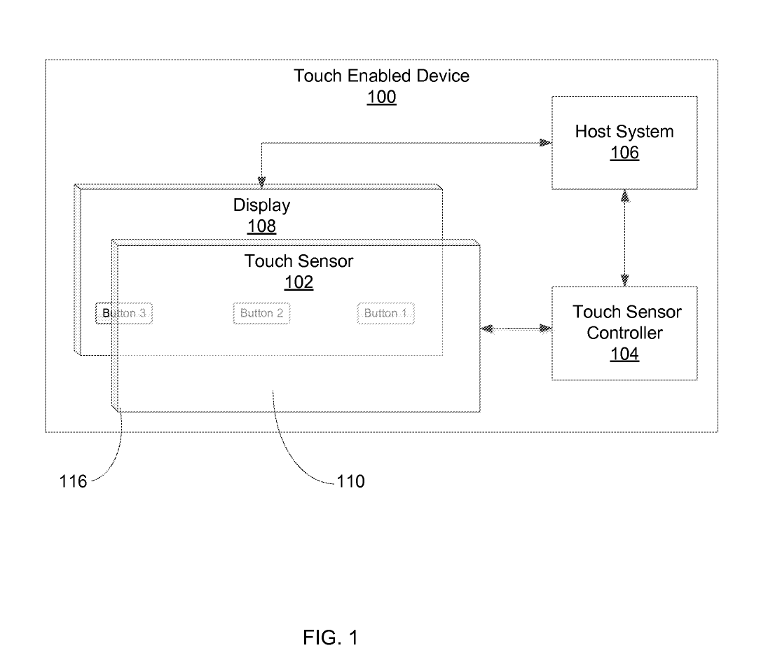

Referring now to the drawing, FIG. 1 is a block diagram of an exemplary touch-enabled device 100, hereinafter, simply device 100, that may include apparatus that implement such improvements and methods. A non-exclusive list of exemplary products that may incorporate or embody device 100 includes tablet computers, touch-enabled personal computers, smart phones, and GPS receivers. Generally, any device having a user interface that incorporates touch interaction may form the touch-enabled device 100.

An exemplary embodiment of the exemplary device 100 includes a touch sensitive surface, hereinafter touch sensor 102, an exemplary touch sensor controller, hereinafter controller 104, a host system 106 and a display 108. The controller 104 is electrically connected to the touch sensor 102 and the host system 106. In an exemplary embodiment, the touch sensor 102 is in mechanical proximity to the display 108 such that the bottom surface 112 of the touch sensor 102 is adapted to contact the display surface 114 of display 108 or another layer disposed between the display surface 114 of the display and the bottom surface 112 of the touch sensor 102. By way of example and without limitation, an adhesive may be used to secure the display 108 to the touch sensor 102. In this example, the touch sensor 102 is transparent or translucent so that visual elements displayed at display 108 are visible through the touch sensor 102. An example of a transparent or translucent touch sensor is the touch sensor commonly used in a tablet computer or smart phone. In other embodiments, touch sensor 102 may be opaque. An example of an opaque touch sensor is a laptop touch pad. As is explained in detail below, in response to a touch, touch sensor 102 is adapted to produce a measurable change in an electrical attribute of the touch sensor 102.

The controller 104 generally includes one or more circuits, processors software, or any combination of these, to provide signals to the touch sensor and receive signals from the touch sensor 102. In an embodiment, controller 106 may be adapted with connectors to allow controller 104 to be electrically and mechanically coupled to touch sensor 102. The controller 104 is programmed or configured to measure the changes in the electrical attribute produced by the touch sensor 102 in response to a touch. Based on the measured changes, controller 104 is configured to determine the location of the touch.

The host system 106 generally includes one or more circuits, processors or software in data communication with the controller 104 and operable to control the operation of controller 104. In some exemplary embodiments, the host system includes one or more processors and memory in data communication with the one or more processors to store data and instructions for operation of the one or more processors. The stored data and instructions may form one or more applications which provide specified functionality and user features. Further, in some exemplary embodiments, the host system 106 includes a graphical user interface implemented by hardware components such as a processor, software components including data and instructions stored in memory, or a combination of hardware components and software components. The host system 106 is configured to receive, from controller 104, information of the location of a touch of touch sensor 102. Based on this information, host system 106 may cause one or more applications to execute application-specific functions.

In the embodiment of FIG. 1, as previously discussed, a processor of host system 106 may execute applications stored in the host system 106 and display graphic elements of the graphical user interface (GUI) of the executed applications at the display 108. Examples of applications include mapping applications or web browsing applications. A user may interact with the GUI of the applications by touching a location on the top surface 110 of the touch screen 102 that is directly above a GUI element, for example. A user may use one or more fingers or a stylus to touch the top surface 110. When touched, the touch sensor 102 responds to the touch by producing a measurable change of a physical characteristic such as resistance or capacitance. As will be discussed below, in some embodiments, touch sensor 102 includes elements that respond to a touch by producing a change in capacitance. The controller 104 is in signal communication or data communication with the touch sensor 102 and is configured to detect the change and determine the location of the touch based on the change in the physical characteristic. The controller 104 is further configured to communicate the location of the touch to the host system 106. For example, the touch sensor controller 104 may communicate data defining the two-dimensional coordinates of the location of the touch referenced from a corner of touch sensor 102, for example, corner 116. Corner 116 may be referred to as the origin. Polar coordinates and Cartesian coordinates are examples of two-dimensional coordinates systems. The host system 106 communicates the coordinates of the location of the touch to the application. The application may react to the coordinate information by executing functionality associated with the GUI element.

An application may also be configured to receive user input by way of touch gestures traced with one or more fingers on the surface 110 of touch sensor 102. A gesture performed by moving a single finger while contacting the surface 110 of touch sensor 102 may be referred to as a single touch gesture. A gesture performed while contacting surface 110 with two or more fingers and moving the fingers while contacting the surface 110 may be referred to as a multi-touch gesture. Examples of single touch gestures are a swipe motion performed by contacting the surface 110 of touch sensor 102 with a finger and moving the finger across the surface 110 while maintaining contact with the surface 110. Tracing a circle with two fingers, referred to as a rotate gesture, and pinching two fingers either together or apart while contacting the surface 110 are examples of multi-touch gestures. In an exemplary embodiment, in response to a single or multi-touch gesture, controller 104 may detect the initial location of the touch or touches when the gesture is initiated, track the location of the touch or touches as the gesture is performed, and report the coordinates of the location of the touch or touches to host system 106. Controller 104 may report the coordinates continuously, periodically or in response to controller 104 receiving a request from host 106 for coordinates.

In some embodiments, touch sensor 102 implements capacitance-based touch sensing technology and may be referred to as a capacitive touch sensor 102. Generally, touching a capacitive touch sensor produces a localized change in capacitance at the approximate location where the capacitive touch sensor 102 is touched. Controller 104, when coupled to a capacitive touch sensor 102, localizes the approximate location of a touch of the capacitive touch sensor 102 by determining the location of the capacitance change and reports the coordinates of the location of the touch to host system 106. Any suitable technique, circuit or routine may be used for localizing a touch or touches of the surface. Surface capacitance and projected capacitance are examples of capacitance based touch sensing technologies. Mutual-capacitance and self-capacitance are types of projected capacitance touch sensing technologies. In an exemplary embodiment, described in greater detail in the following discussion, touch sensor 102 is a self-capacitance touch sensor.

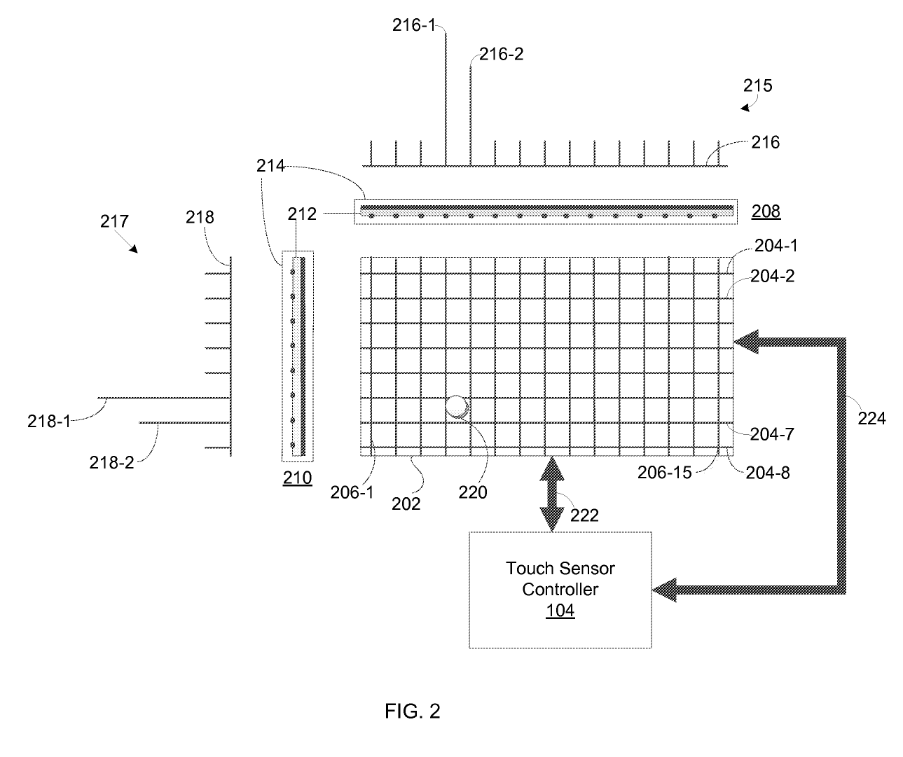

FIG. 2 is a combined functional and structural block diagram of an exemplary self-capacitance touch sensor 202 electrically coupled to controller 104 of FIG. 1. Self-capacitance touch sensor 202 includes an array of row electrodes 204-1 to 204-8 that run along the length of touch sensor 202 and an array of column electrodes 206-1 to 206-15 that run along the width of touch sensor 202. Note that not all row electrodes and not all column electrodes are numbered in FIG. 2 so as to not unduly complicate the drawing figure. Spatially, the row electrodes may be located in one geometric plane and the column electrodes may be located in a second parallel geometric plane.

Each electrode of the row electrodes 204-1 to 204-8 and the column electrodes 206-1 to 206-15 is characterized as having a proximal end and a distal end. The distance between the proximal end and the distal end corresponds to the length of the electrode. The row electrodes 204-1 to 204-8 and the column electrodes 206-1 to 206-15 may be composed of a conductive material. A non-limiting list of materials that may be used to construct the column and row electrodes includes indium tin oxide, silver nanowire and metal mesh.

A cross-section of touch sensor 202 along the length of row electrode 204-1 is illustrated as length-wise cross-sectional view 208. A cross-section of touch sensor 202 along the length of column electrode 206-1 is illustrated as width-wise cross-sectional view 210. As depicted in the length-wise cross-sectional view 208 and the width-wise cross-sectional view 210 the row electrodes and column electrodes are electrically isolated from each other by an insulating layer 212. The combination of the row and column electrodes and the insulating layer 212 may be encapsulated in shield 214, in one embodiment. In another embodiment, row and column electrodes may be separated by insulating layer 212 and the shield 214 may face away from the touch surface and may be adjacent to the display 108 (FIG. 1).

The proximal end of each row electrode 204-1 to 204-8, and each column electrode 206-1 to 206-15, is electrically connected to controller 104 via bus 222 and bus 224, respectively. In one embodiment, the buses 222, 224 that electrically connect the row and column electrodes with controller 104 so as to not materially change the operational characteristics of the electrodes. In another embodiment, the buses 222, 224 may alter the operational characteristics of the electrodes.

Returning to the electrode, the end of an electrode that is floating or not connected to controller 104 may be referred to as the distal end. Generally, in the absence of a touch, a row or column electrode, hereinafter simply an electrode, presents a capacitance value to the controller 104. Respective instantaneous capacitance values of the column electrodes are represented by graph 215. Similarly, respective instantaneous capacitance values of the respective row electrodes are represented by graph 217. Magnitude of the respective instantaneous capacitance values of the respective column electrodes and row electrodes are generally indicated by the length of the respective line in graph 215 and graph 217. The capacitance values of the row and column electrodes may be measured in any suitable manner to derive a value usable by the controller 104.

The capacitance value presented by an electrode in the absence of a touch may be referred to as the baseline capacitance value and is depicted in FIG. 2 as level 216 for the column electrodes and level 218 for the row electrodes. The baseline capacitance corresponds to the parasitic capacitance between the electrode and the physical surroundings. The baseline capacitance is also is a function of a non-limited list of structural, material and geometrical attributes that includes the length of the electrode, the inter-electrode distance, the material of the insulating layer 212 and the shield 214.

When the self-capacitance touch sensor 202 is touched in the proximity of an electrode, the capacitance value presented by that electrode changes or deviates from the baseline capacitance value. The change in capacitance or deviation from the baseline capacitance is hereinafter simply referred to as capacitance change. For example, when touch screen 202 is touched at location 220, the capacitance presented by row electrodes 204-8 and 204-7 changes from the baseline capacitance 218 by a magnitude represented by the height of bars 218-1 and 218-2, respectively. Similarly the capacitance presented by column electrodes 204-4 and 204-5 changes from the baseline capacitance 216 by a magnitude represented by the height of bars 216-1 and 216-2, respectively. The magnitude of the height of bars 216-1 and 216-2 is proportional to the magnitude of the change in capacitance. The proportionality in this example is linear, but any proportional measure such as exponential or logarithmic, may be used. In this embodiment, the location on the surface 202 of the touch 220 corresponds to the intersection of the row and column electrodes associated with the largest capacitance change from their respective capacitance baselines. The touch sensor controller 104 detects the change in correspondence and determines the location.

Controller 104 implements methods to measure the capacitance presented by the row and column electrodes. Several methods are available to measure the capacitance presented by each of the row and column electrodes. A non-exclusive list of capacitance measurement methods includes use of a relaxation oscillator, charge time versus voltage, voltage divider, charge transfer and sigma modulation. Controller 104 may implement any one or combination of the methods listed above or other methods not listed which may be profitably combined with the techniques disclosed herein.

Controller 104 measures the respective capacitance presented by the row and column electrodes. Measuring the respective capacitance presented by the row and column electrodes may be referred to as scanning the electrodes. Controller 104 may analyze the results of the scan. In an embodiment, analyzing the results may include comparing the measured capacitance for the row electrodes with the baseline capacitance 218 and selecting the row electrode that is associated with the largest capacitance change from the baseline capacitance 218. Referring to FIG. 2, controller 104 may identify row electrode 204-8 as being associated with the largest capacitance change. Controller 104 may similarly compare the measured capacitance for the column electrodes with the baseline capacitance 216 and select the column electrode that is associated with the largest capacitance change from the baseline capacitance 216. Referring to FIG. 2, controller 104 may identify column electrode 206-4 are being associated with the greatest capacitance change from baseline capacitance 216. As previously mentioned, controller 104 may conclude that location of touch 220 is approximately located at the intersection of row electrode 204-8 and column electrode 206-4 and communicate the intersection information to host system 106.

In another embodiment, controller 104 may identify row and column electrodes associated with capacitance changes that exceed a threshold. Referring to FIG. 2, in this embodiment, controller 104 may identify row electrodes 204-8 and 204-7 as being associated with capacitance changes 218-1 and 218-2 that exceed a threshold. The threshold may be set by software, such as a valued stored in memory, or by hardware such as a voltage or current or other circuit parameter which is compared with a measured circuit parameter by the controller 104. Further, the controller 104 may identify column electrodes 206-4 and 206-5 as being associated with capacitance changes 216-1 and 216-2 that exceed the same threshold or another threshold. Using this information, controller 104 may calculate the centroid of the rectangle formed by the intersection of column electrodes 206-4 and 206-5 and row electrodes 204-8 and 204-7. The centroid corresponds to geometric center of a two-dimensional region defined by the column electrodes 206-4 and 206-5 and row electrodes 204-8 and 204-7. The centroid may be defined as the arithmetic mean or average of the points in the two dimensional region. Alternatively, some other aspect defining the location of the touch 220 on the surface 202 may be determined. The controller 104 may the communicate centroid information or other determined information to the host system 106 for further processing.

In another embodiment, the controller 104 may merely communicate information of column electrodes 206-4 and 206-5 and row electrodes 204-8 and 204-7 to the host system 106. In such an alternative embodiment, the host system may determine the centroid of the rectangle or other positioning information for the touch or touches on the surface of the touch sensor.

The magnitude of the capacitance change produced by an electrode in response to a given touch is referred to as the sensitivity of the electrode. The sensitivity of the electrode may change based on the characteristics of the object touching the self-capacitance touch sensor 202. However for a given object, generally, the sensitivity of the electrode is uniform along the length of an electrode. The electrode may be said to exhibit uniform sensitivity. This means that, irrespective of where along the length of the electrode, the electrode is touched, the magnitude of the capacitance change is approximately the same. The operational mode of controller 104 that causes row and column electrodes to exhibit uniform sensitivity may be referred to as uniform sensitivity mode.

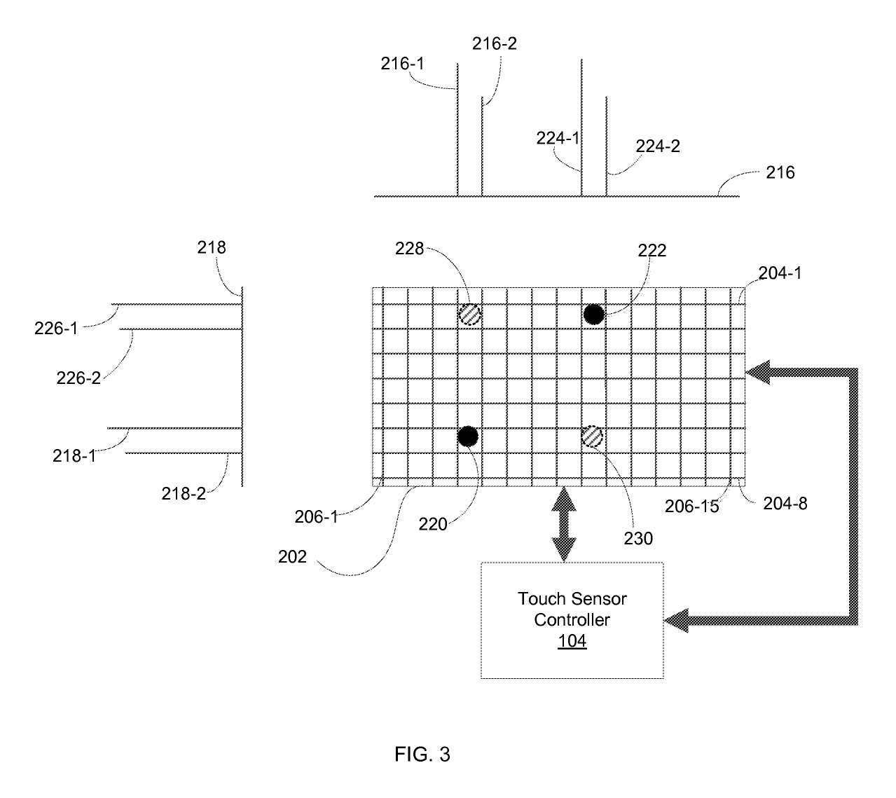

FIG. 3 illustrates the magnitude of capacitance changes presented by row and column electrodes of the example self-capacitance touch sensor 202 shown in FIG. 2 in response to a substantially simultaneous first touch 220 and second touch 222. In this example, controller 104 operates the touch sensor 202 in the previously discussed uniform sensitivity mode. Because the row and column electrodes exhibit uniform sensitivity irrespective of the location of the touch, the magnitude of the capacitance change produced in response to touch 220 and touch 222 is approximately a constant.

Referring to FIG. 3, in response to touch 220, column electrode 206-4 may present a capacitance change having a magnitude 216-1 and column electrode 206-5 may present a capacitance change having a magnitude 216-2. Also, row electrode 204-3 may present a capacitance change having a magnitude 218-1 and row electrode 204-2 may present a capacitance change having a magnitude 218-2. In response to touch 222, column electrode 206-8 may present a capacitance change having a magnitude 224-1 and column electrode 206-9 may present a capacitance change having a magnitude 224-2. Also, row electrode 204-7 may present a capacitance change having a magnitude 226-2 and row electrode 204-8 may present a capacitance change having a magnitude 226-1. The capacitance changes are all detected by touch sensor controller 104.

In the scenario depicted in FIG. 3, controller 104 may identify column electrodes 206-4 and 206-8 as presenting maximum capacitance changes (216-1 and 224-1) from baseline capacitance value 216. Similarly, controller 104 may identify row electrodes 204-3 and 204-8 as presenting maximum capacitance changes (218-1 and 226-1) from baseline capacitance value 218.

Because the row and column electrodes exhibit uniform sensitivity, the magnitude of the maximal capacitance changes 216-1, 224-1, 218-1 and 226-1 are approximately equal. Therefore, in the uniform sensitivity mode, controller 104 may not be able to determine the position of touches 220 and 222 based on the magnitude of the capacitance changes presented by the row and column electrodes proximal to the touch. Controller 104 may only determine that a first touch is located proximate to the intersection of column electrode 206-4 and row electrode 204-3 or proximate to the intersection of column electrode 206-4 and row electrode 204-8. The intersection of column electrode 206-4 and row electrode 204-3 corresponds to the actual location of touch 220. Location 228, located at the intersection of column electrode 206-4 and row electrode 204-8, corresponds to the incorrect location of touch 220. One skilled in the art will recognize location 228 as a ghost touch. Separately, controller 104 may determine that a second touch is located proximate to the intersection of column electrode 206-8 and row electrode 204-3 or proximate to the intersection of column electrode 206-8 and row electrode 204-8. The intersection of column electrode 206-8 and row electrode 204-8 corresponds to touch 222. Similarly, location 230 located the intersection of column electrode 206-8 and row electrode 204-3 corresponds to an incorrect location of touch 222 or a ghost touch location.

In an exemplary embodiment, controller 104 operates to cause the sensitivity of an electrode to be position dependent. This means that, for a given object touching an electrode, the magnitude of the capacitance change produced when the electrode is touched changes based on where along the length of the electrode, the electrode is touched. This may be referred to as position-dependent sensitivity. The operational mode of controller 104 that causes row and column electrodes to exhibit position-dependent sensitivity may be referred to as position-dependent sensitivity mode. For example, the sensitivity of the electrode may be manipulated by controller 104 such that the magnitude of capacitance change when the proximal end of the electrode is touched is different from the magnitude of capacitance change when the midpoint of the electrode is touched which in turn is different from the magnitude of capacitance change when the distal end of the electrode is touched. In this exemplary embodiment, controller 104 may determine the location of the touch by analyzing the magnitude of the capacitance change for either the row or column electrodes. In this embodiment, controller 104 may identify an electrode corresponding to a touch based on determining that the capacitance change presented by the electrode is above a threshold. Based on the magnitude of the capacitance change, controller 104 may locate the touch on the electrode.

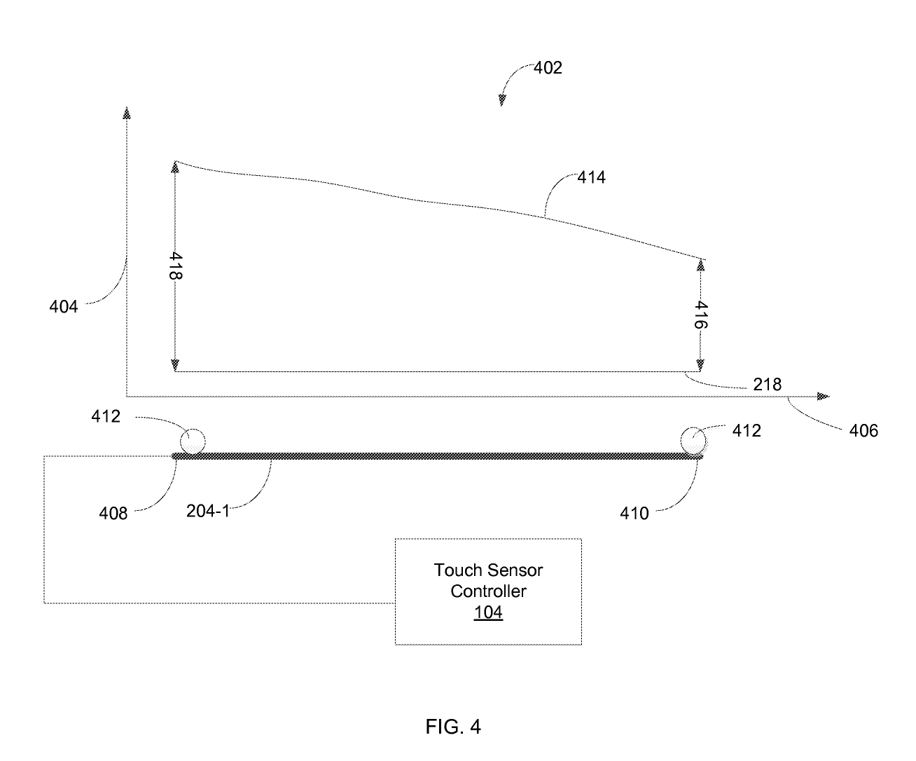

Methods implemented by controller 104 may produce the position-dependent sensitivity of row electrode 204-1, for example, illustrated by graph 402 of FIG. 4. Capacitance presented by the row electrode 204-1 is represented on the vertical axis 404 of graph 402 and the distance of the touch from the proximal end 408 of row electrode 204-1 is represented on the horizontal axis 406 of graph 402. As explained with reference to FIG. 2, when not touched, row electrode 204-1 presents a baseline capacitance value 218. Line 414 represents the magnitude of capacitance change from the baseline capacitance value 218 as a function of the position of a touch along the length of row electrode 204-1. For example, when distal end 410 of row electrode 204-1 is touched by finger 412, the magnitude of the capacitance change from the baseline 218 is capacitance value 416. Similarly, when proximal end 408 of row electrode 204-1 is touched by finger 412 the magnitude of the capacitance change from the baseline 218 is capacitance value 418.

To determine the relationship between the location of a touch of an electrode and the magnitude of the capacitance change caused by the touch, a suitable calibration procedure may be performed during the manufacture of the self-capacitance touch sensor 202 (FIG. 2). Calibrating the self-capacitance touch sensor 202 may include storing one or more pairs of magnitude of capacitance change data and data defining a respective distance of a touch from the proximal or distal end of an electrode, row electrode 204-1 for example. For example, during calibration, electrode 204-1 may be touched at distal end 410 and the magnitude of capacitance change 416 may be measured. The distance of the touch from the proximal end 408, which in this case is the length of the electrode 204-1, and the measured magnitude of capacitance change 418 may correspond to one capacitance-distance pair. Electrode 204-1 may be touched at proximal end 408 and the magnitude of capacitance change 418 may be measured. The distance of the touch from the proximal end, which in this case is zero and the measured magnitude of capacitance change may form the second capacitance-distance pair. In an embodiment, the first capacitance-distance pair and the second capacitance-distance pair may be stored in memory such as non-volatile memory (not shown) of controller 104. The controller 104 may use the stored capacitance-distance pair values to generate an equation that relates the location of the touch along the length of the electrode 204-1 to measured magnitude of capacitance change. In another embodiment, a calibration system (not shown) may determine an equation and store coefficients of the equation in non-volatile memory (not shown) of controller 104.

If the relationship between the location of the touch and the corresponding magnitude of capacitance change is linear, a first order linear equation, such as depicted by Equation 1, may be employed by the touch sensor controller 104 to localize the approximate location of a touch of a row or column electrode. Other embodiments are contemplated, where any one of a quadratic, logarithmic, exponential or any order non-linear equation may be employed to localize the approximate location of a touch of a row or column electrode.

Y=mX+c (Equation 1)

As previously stated, a calibration system or controller 104 may calculate the coefficients, “m” and “c”, of Equation 1 from the previously described capacitance-distance pairs. One of ordinary skill in the art will recognize that the value m corresponds to the slope of line 414 and the value c is the vertical intercept or y-intercept of line 414. The value Y corresponds to the magnitude of the capacitance change and the value X is the distance of the touch from proximal end 408 of row electrode 204-1.

During normal operation of device 100 (FIG. 1), as previously explained, controller 104 scans the electrodes 204-1 to 204-8 and 206-1 to 206-15 of the self-capacitance touch sensor 202 and measures the capacitance presented by the electrodes. The method of scanning used may cause the electrodes to exhibit position-dependent sensitivity. In an embodiment, controller 104 may determine that an electrode was touched if the capacitance presented by the electrode exceeds a threshold. In this embodiment, controller 104 may determine the location of the touch by using the magnitude of the capacitance change presented by the electrode and the previously stored coefficients. For example, by using Equation 1, controller 104 may compute the distance X of the touch from proximal end 408 by using the measured capacitance Y and previously calculated coefficients m and c.

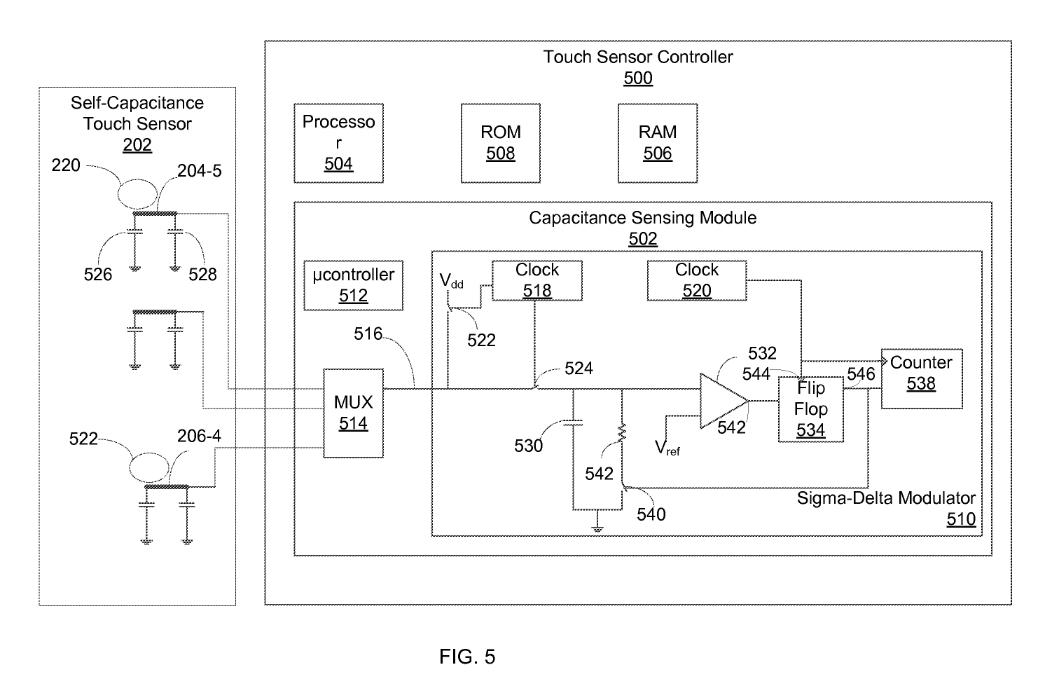

FIG. 5 is a block diagram of an exemplary touch sensor controller, hereinafter, controller 500, illustrated in conjunction with self-capacitance touch sensor 202. Controller 500 may correspond to touch sensor controller 104 of FIGS. 1 and 2. Controller 500 may be configured to conditionally operate in either the position-dependent sensitivity mode or uniform sensitivity mode. In an embodiment, controller 500 is a system on a chip (SOC). In other embodiments, controller 500 may include a combination of discrete and integrated circuit componentry for performing the functions described herein. Further, controller 500 may include software and instructions for performing the functions described herein.

In the embodiment of FIG. 5, controller 500 comprises a capacitance sensing module (CSM) 502, processor 504, random access memory (RAM) 506 and read-only memory (ROM) 508. Controller 500 may be connected to the row and column electrodes of self-capacitance touch sensor 202. Processor 504 may be any conventional data processing circuit such as a core processor or custom designed logic to perform the functions described herein with suitable software code and data. ROM 508 may be any non-volatile memory storage such as flash or other electrically erasable programmable read only memory. ROM 508 may be used to store executable machine instructions, or hereinafter simply instructions. RAM 506 may be any volatile storage such as static RAM, dynamic RAM, dual data rate RAM etc. In an embodiment, processor 504 may copy instructions stored in ROM 508 and store the copied instructions in RAM 506. During normal operation, the processor 504 may fetch instructions stored in RAM 506 and execute the fetched instructions. In a preferred embodiment, the instructions stored in ROM 508 when executed by processor may cause the CSM 502 to measure the capacitance presented by the row and column electrodes. Processor 504 may execute instructions stored in memory such as ROM 508 to determine the location of a single touch and a multi-touch based on the measured capacitances. In some embodiments, ROM 508 may store the coefficients for an equation, Equation 1 for example, that processor 504 may use to compute the location of a touch based on the measured capacitance presented by the row and column electrodes. The stored data may be obtained or produced during a calibration procedure. Processor 504 may also program elements of CSM 502 to cause the row and column electrodes to exhibit the previously described position-dependent sensitivity.

In an embodiment, CSM 502 comprises a microcontroller 512, a multiplexer 514 and a sigma-delta modulator 510. Microcontroller 512 may be any data processing unit. Typically, microcontroller 512 operates the other components of CSM 502 in accordance with instructions received from processor 504. Multiplexer 514 is a combinatorial logic device that is characterized by multiple inputs and a single output 516. Multiplexer 514 may also be characterized by one or more control lines (not shown). In a preferred, an input of multiplexer 514 may be connected to a row or column electrode. By operating the control lines, one of the inputs may be connected to the output 516. Multiplexer 514 enables a single sigma-delta modulator 510 to be used to measure the capacitance presented by electrodes connected to the input of the multiplexer 514.

By way of example and without limitation, sigma delta modulator 510 comprises clock 518, clock 520, switch 522, switch 524, switch 540, capacitor 530, resistor 542, comparator 532, flip flop 534 and counter 538. Clocks 518 and 520 include combinatorial circuitry that may be configured to produces a timing signal or a clock signal. A typical timing signal is a square wave, but the embodiments described herein are not limited to a square wave. The timing signal may also be a spread spectrum or pseudo random wave form. Clock 518 and clock 520, in some embodiments, may comprise an oscillator such as a crystal or temperature controlled oscillator (TCXO) and a phase locked loop (PLL), although any type of suitable timing device or hardware or software module may be used. By programming the PLLs with different values, clock 518 and clock 520 may be used to generate timing signals having different frequencies.

In an exemplary embodiment, switch 522, switch 524 and switch 540 are electronic switching devices that switch states when an external control voltage is applied. Typically, an electronic switching device comprises an input line, an output line and a control line or a bias line. In the absence of a signal at the bias line, the electronic switching device is in a high impedance state and the input line is not connected to the output line. When a signal of the appropriate polarity and amplitude is applied to the control line, the electronic switching device enters a low impedance state and the input line is connected to the output line. Causing a switch to enter the low impedance state by applying a signal to the control line may be referred to as operating the switch. Bipolar-junction transistors and field effect transistors are examples of electronic switching devices although any other suitable device may be used to perform the described operations.

Comparator 532 compares voltages or currents applied as input signals at its respective two inputs and provides as an output a digital signal indicating which one of the two input signals is larger in magnitude. For example, if the voltage at the first input is greater than the voltage at the second input, the signal at the output 542 of comparator 532 may be logic high. Conversely, if the voltage at the first input is lesser than the voltage at the second input, the signal at the output 542 of comparator 532 may be logic low. In an exemplary embodiment, comparator 532 may be implemented as an open-loop operational amplifier with one input tied to a reference voltage or current for comparing with an input voltage or current at the other input. Any other suitable device or module may be substituted, however.

Flip flop 534 is a sequential logic circuit that may be used to store a single bit of information. Typically flip flop 534 may be implemented using combinatorial logic elements like NAND or NOR logic gates. In the embodiment of FIG. 5, flip flop 534 is configured to operate as a transparent latch. In this configuration, a control input of flip flop 534 is connected to the output 542 of comparator 532 and the output of clock 520 is connected to clock input 544 of flip flop 534. When the signal at the output 542 of comparator 532 is active, for example logic high, the clock signal available at the output of clock 520 is reflected at the output 546 of flip flop 534.

Counter 538 is a combinatorial and sequential logic element that keeps count of the number of time an event occurs. Typically, a clock input of a counter is connected to an output of a clock signal source, clock 520 for example. In this embodiment, counter 538 increments a count for each cycle of the clock signal. In this embodiment, when the output 542 of comparator 532 is active, the clock signal available at the output of clock 520 that is reflected at the output 546 of flip flop 534 causes the count of counter 538 to increment. As is explained in the foregoing discussion, the count of counter 538 corresponds to the capacitance presented by a row or column electrode that is connected to the output 516 of multiplexer 514.

As previously mentioned, several capacitance sensing modalities are known. In the exemplary controller 500, CSM 502 implements the sigma delta method to measure the respective capacitance presented by the row and column electrodes. In some embodiments, processor 504 may perform the functions ascribed to microcontroller 512 or vice versa.

In FIG. 5, the controller 500 is illustrated generally in conjunction with a touch sensor, self-capacitance touch sensor 202. The proximal ends of the row electrodes 204-1 to 204-8 and column electrodes 206-1 to 206-15 of self-capacitance touch sensor 202 of FIG. 2 are connected to inputs of the MUX 514. The MUX 514 operates as a switch under control of the microcontroller 512 to selectively couple respective row electrodes and column electrodes to the sigma-delta modulator 510. In an embodiment, microcontroller 512 may receive the instruction from processor 504 to measure the capacitance presented by row electrodes 204-1 to 204-8 and column electrodes 206-1 to 206-15 of self-capacitance touch sensor 202 of FIG. 2. In response to being instructed by processor 504, microcontroller 512 may operate MUX 514 to connect an electrode (row or column) to the input 516 of sigma delta modulator 510. Microcontroller 512 may instruct sigma delta modulator 510 to measure the capacitance presented by the electrode that is connected to the input 516. In an embodiment, sigma-delta modulator 510 measures the capacitance presented by the electrode that is connected to the input 516. The sigma-delta modulator 510 produces, and microcontroller 512 receives a signal or data value corresponding to the measured capacitance value. The method used by sigma-delta modulator 510 to measure the capacitance presented by an electrode connected to input 516 is discussed in detail below. Microcontroller 512 may then connect another electrode to the input 516 by reconfiguring the MUX 514 and repeat the process.

Sequentially connecting the row electrodes to the input 516 and measuring the respective capacitance presented by the connected row electrode may be referred to as a row scan. Sequentially connecting the column electrodes to the input 516 and measuring the respective capacitance presented by the column electrodes may be referred to as a column scan. Data corresponding to the measured capacitance for a scan of the row electrodes may be collectively referred to as row scan data and data corresponding to the measured capacitance for a scan of the column electrodes may be collectively referred to as column scan data. The row scan data and column scan data may collectively be referred to as scan data. Microcontroller 512 may report the column scan data and row scan data to processor 504. Processor 504 may determine the position of the touch 220 by analyzing the scan data. In a preferred embodiment, processor 504 may operate the CSM 502 to cause the row and column electrodes to exhibit the position-dependent sensitivity detailed above with reference to FIG. 3 and may localize the position of a single touch 220 (FIG. 2) by analyzing only the row scan data or only the column scan data. In this embodiment, processor 504 may also analyze the row scan data and the column scan data to determine the position of a first touch 220 (FIG. 5) and a second touch 222 (FIG. 5).

The operation of sigma-delta modulator 510 is now described with reference to a single electrode. For the purpose of this discussion, row electrode 204-5 of FIG. 2 is connected to an output 516 of the MUX 514. Row and column capacitances of the touch sensor 202 are modelled with the capacitances illustrated in FIG. 5. Capacitance 526 corresponds to the baseline capacitance of row electrode 204-5 and capacitance 528 corresponds to the capacitance produced in response to touch 220 (FIGS. 2, 4 and 5), for example.

Sigma delta modulator 510 includes a first clock 518 and a second clock 520. Each respective clock of the first clock 518 and the second clock 520 has a respective operating frequency which may be selectively set or programmed by processor 504. In an embodiment, the operating frequency of the first clock 518 and the operating frequency of the second clock 520 determine if the row and column electrodes exhibit uniform sensitivity or position-dependent sensitivity. In a preferred embodiment, processor 504 may program the operating frequency of first clock 518 and the operating frequency of the second clock 520 with values that cause the row and column electrodes to exhibit position-dependent sensitivity.

The clock signal produced by clock 518 operates the switch 522 and switch 524. In an embodiment, during the first half of the clock cycle, switch 522 is closed and switch 524 is open. During the second half of the clock cycle switch 522 is open and switch 524 is closed. When row electrode 204-5 is connected to input 516, during the first half of the clock cycle, voltage V_{dd} charges the capacitors 526 and 528. V_{dd} may be any suitable voltage value, such as the most-positive voltage available in the circuit. During the second half of the clock cycle, a portion of the charge stored in the capacitor corresponding to capacitances 526 and 528 is transferred to capacitor 530. The process of charging the capacitances 526 and 528 during the first half of the clock cycle and transferring the stored charge to capacitor 530 during the second half of the clock cycle continues until the voltage developed across capacitor 530 exceeds the reference voltage V_{ref}. When the voltage developed across capacitor 530 exceeds V_{ref}, the output signal produced by comparator 532 transitions to an active state. The active state of the output of comparator is latched into flip flop 534 and is reflected at the output 546 of flip flop 534. The signal at the output 546 enables counter 538 and simultaneously closes switch 540.

After counter 538 is enabled, the count value in counter 538 increments (or decrements) at a rate determined by the frequency of the clock signal produced by clock 520. In this embodiment, the count value in counter 538 increments as long as the charge stored in capacitor exceeds 530 V_{ref}.

The charge stored in capacitor 530 discharges or dissipates through bleed resistor 542 and the closed switch 540. Discharge of this charge causes the voltage developed across capacitor 530 to decrease. While capacitor 530 discharges, charge stored in the capacitor corresponding to capacitances 526 and 528 continues to be transferred to capacitor 530 whenever switch 524 is closed. This affects the rate of discharge. The rate of discharge is also determined by the resistance of bleed resistor 542 and the capacitances 526. 528. When the voltage across capacitor 530 falls below the threshold voltage V_{ref}, the output signal produced by comparator 532 transitions to the inactive state. The inactive logic state of the output of comparator 532 is latched into flip flop 534 and is reflected at the output 546 of flip flop 534. The signal at the output 536 disables counter 538 and simultaneously opens switch 540.

In this embodiment, when operated in uniform sensitivity mode, the value or magnitude of the count in counter 538 is proportional to the magnitude of the capacitances 526 and 528 presented by row electrode 204-5 connected to input 516. When operated in position-dependent sensitivity mode, the value or magnitude of the count in counter 538 is proportional to not only the magnitude of the capacitances 526 and 528 presented by row electrode 204-5 connected to input 516 but also to where along the length of row electrode 204-5, between the proximal end and the distal end of the electrode, the touch is located. Thus, in an embodiment, a higher count represents a touch location closer to the proximal end of an electrode and a lower count represents a touch location closer to the distal end of the electrode.

In an embodiment, microcontroller 504 may cause sigma delta modulator 510 to obtain several measurements of the capacitance presented by the electrode connected to the output 516 of MUX 514. Microcontroller 504 may apply a suitable statistical formula to the several measurements to generate a new measurement. For example, microcontroller 512 may average the several measurements to obtain a single count. Any other statistical relationship or other technique may be substituted as well.

As previously mentioned, microcontroller 512 may sequentially scan the row and column electrodes and report the resulting scan data to processor 504. A data point in the scan data corresponds to the value of the count of counter 538 for a respective electrode. In this embodiment, the Y value of Equation 1 corresponds to the value of the count. In an embodiment, for each electrode, processor 504 may compare the value of the count with a threshold to determine if the corresponding electrode is touched. In response to determining that the electrode is touched, processor 504 may substitute the coefficients m and c and the value of the count Y into Equation 1 and solve Equation 1 to determine the location X of the touch 220.

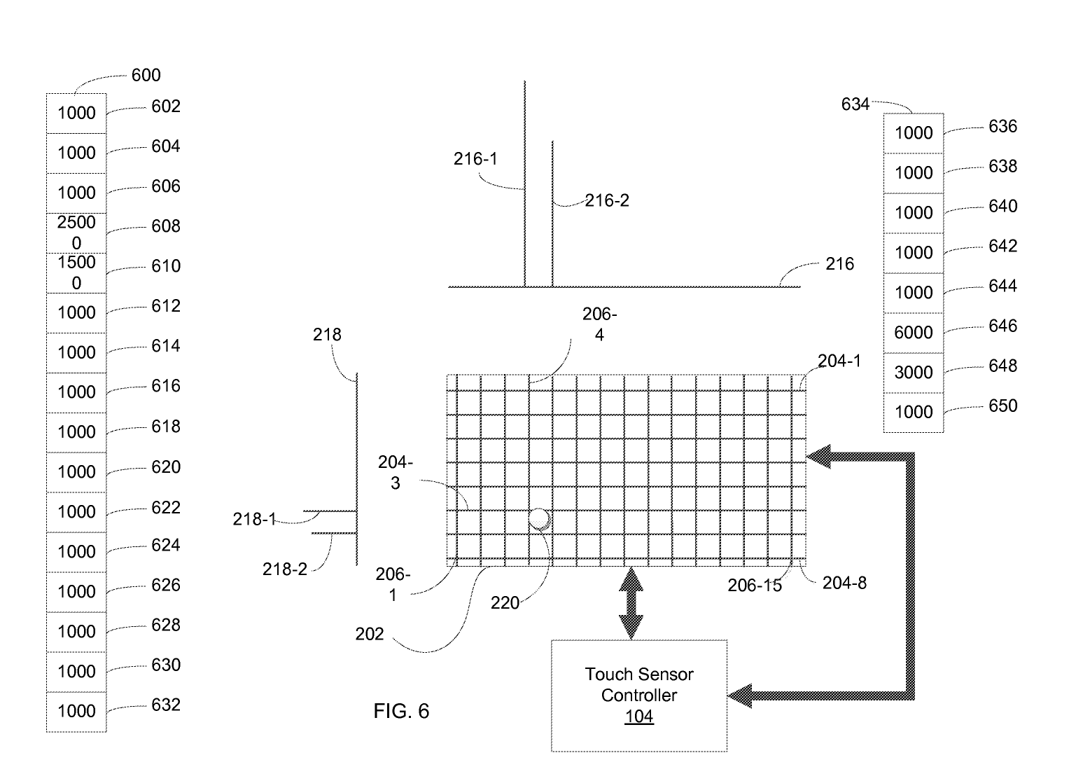

FIG. 6 depicts a single-touch scenario where the controller 104 implements methods that cause the electrodes 204-1 to 204-8 and 206-1 to 206-15 to exhibit position-dependent sensitivity. In this scenario, single-touch 220 is approximately located on column electrode 206-4 and row electrode 204-3. Single-touch 220 is located closer to the proximal end of column electrode 206-4 and closer to the distal end of row electrode 204-3.

The embodiment of FIG. 6 also shows generally scan buffers 600 and 634. The scan buffers 600, 634 store data corresponding to the respective measured capacitances for the row and column electrodes. In an embodiment, the scan buffers 600, 634 may be formed using any suitable memory components such as RAM 506 of the controller 500 shown in FIG. 5. In another embodiment, scan buffers 600, 634 may correspond to internal memory elements such as scratch pad RAM (not shown) of microcontroller 512. In another embodiment, scan buffers 600, 634 may be implemented as dual port RAM (DPRAM). In this embodiment, the scan buffers 600, 634 are in data communication with the microcontroller 512 and processor 504. In this embodiment, scan buffers 600, 634 receive data from microcontroller 512 and provide stored data to processor 504.

In an embodiment, controller 104 may correspond to controller 500 of FIG. 5. In this embodiment, processor 504 may configure the operating frequency of clocks 518 and 520 to cause the sigma-delta modulator 510 to operate in the position-dependent sensitivity mode. In this embodiment, in response to a request for scan data, microcontroller 512 may scan the row and column electrodes to measure the respective counts produced by the electrodes based on their respective capacitances.

Microcontroller 512 may communicate scan data for the row and column electrodes to processor 504 via scan buffers 600, 634. Scan buffer 600 may comprise entries containing the respective values of the counter 538 produced during the scan of column electrodes 206-1 to 206-15. For example, entry 602 may contain the value of counter 538 when electrode 206-1 is connected to the output 516 of MUX 514 during the scan of the column electrodes. Similarly, entry 606 may contain the value of counter 538 when electrode 206-4 is connected to the output 516 of MUX 514 during the scan of the column electrodes. Scan buffer 634 may comprise the respective values of the counter produced during the scan of row electrodes 204-1 to 204-8. In this example, when an electrode is not touched, its baseline capacitance corresponds to a count value of 1000.

In this embodiment, processor 504 may analyze the entries 602 to 632 of scan buffer 600 to identify the entry with the largest count value. In the scenario of FIG. 6, processor 504 may identify entry 608 as having the largest count value. Count value in entry 608 corresponds to the magnitude of the capacitance change presented by column electrode 206-4.

Referring to Equation 1, in this embodiment, processor 504 may use the magnitude of the capacitance change contained in entry 608 (Y) and the coefficients m and c, to localize the position (X) of touch 220 on column electrode 206-4. One of ordinary skill in the relevant art will recognize that, in this exemplary embodiment, the magnitude of the capacitance change presented by a column electrode, 206-4 for example, implicitly identifies the row electrode, 204-3 for example, proximal to the single-touch 220. By way of example and without limitation, scan data for the column electrodes are used to localize the position of touch 220. In another embodiment, scan data for the row electrodes may instead be used to localize the position of touch 220.

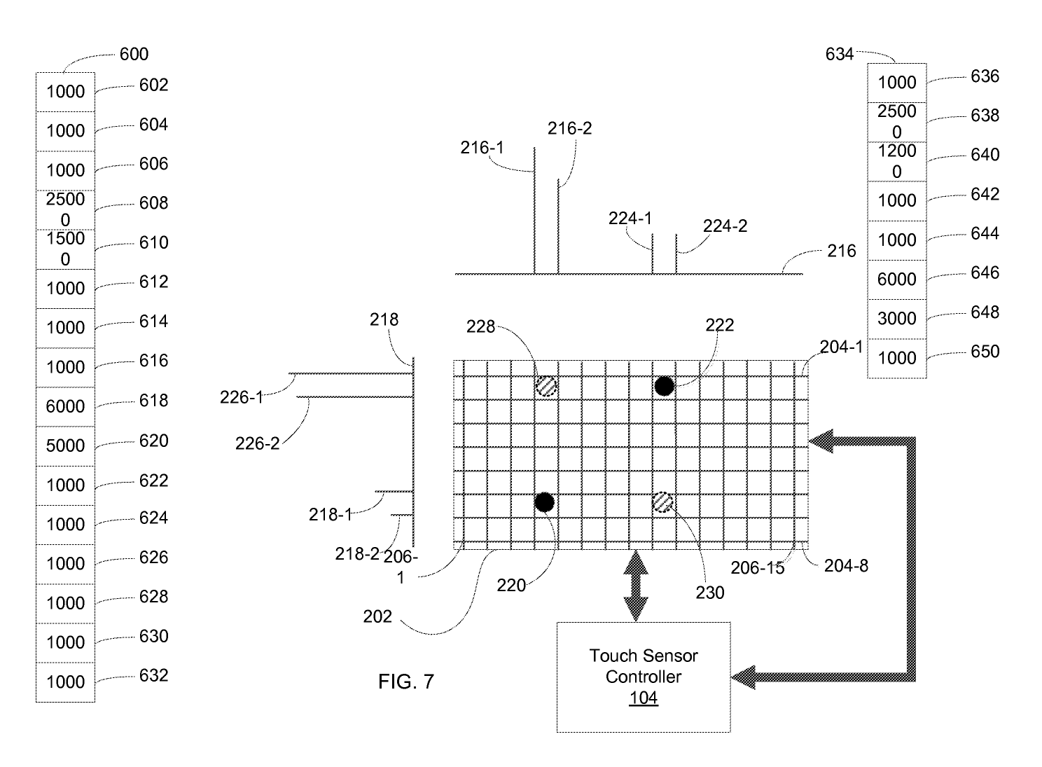

In some embodiments, controller 104 may utilize the discussed position-dependent sensitivity to determine the location of a multi-touch of the self-capacitance touch sensor 202 (FIG. 2). FIG. 7 depicts such a multi-touch scenario where the self-capacitance touch sensor 202 of FIG. 2 is substantially simultaneously touched at a first location 220 and a second location 222. By operating the controller 104 in the position-dependent sensitivity mode, controller 104 may be able to discriminate between the locations of first touch 220 and second touch 222 and the ghost touches 228, 230.

Entries 602 to 632 of column scan buffer contain exemplary respective count value obtained by microcontroller 512 during the scan of column electrodes 206-1 to 206-15, respectively. Entries 636 to 650 of row scan buffer 634 contain exemplary respective count value of counter 538 obtained by microcontroller 512 during the scan of row electrodes 204-1 to 204-8, respectively. In an exemplary embodiment, processor 504 may analyze count values in data entries 602 to 632 in column scan buffer 600. For example, processor 504 may determine which data entries contain count values that exceed a count value threshold indicating a touch. Based on the count values for data entries 608 and 618, processor 504 may determine that the first touch 220 is proximal to column electrode 206-4 and that the second touch 222 is proximal to column electrode 206-9. Because the controller 500 is operating in position-dependent sensitivity mode and because touch 222 is located closer to the distal end of column electrode 206-9 and because touch 220 is located closer to the proximal end of column electrode 206-4, count value in data entry 618 corresponding to column electrode 206-9 is smaller than the count value in data entry 608 corresponding to column electrode 206-4.

As previously described, processor 504 may utilize the calibration coefficients (m and c) and the count value in data entry 608 (Y) in Equation 1 and calculate the location of touch 220 along length of electrode 206-4. This location implicitly identifies the appropriate row electrode 204-6 proximal to touch 220. Thus, processor 504 may utilize the position-dependent sensitivity of the electrodes to discriminate between the appropriate row electrode 204-6 and the “ghost” row electrode 204-1 corresponding to ghost touch 228. Similarly, processor 504 may utilize the calibration coefficients (m and c) and the count value in data entry 618 (Y) in Equation 1 and calculate the location of touch 222 along length of electrode 206-9. This location implicitly identifies the appropriate row electrode 204-1 proximal to touch 222. Thus, processor 504 may utilize the position-dependent sensitivity of the electrodes to discriminate between the appropriate row electrode 204-1 and the ghost row electrode 204-6 corresponding to ghost touch 230.

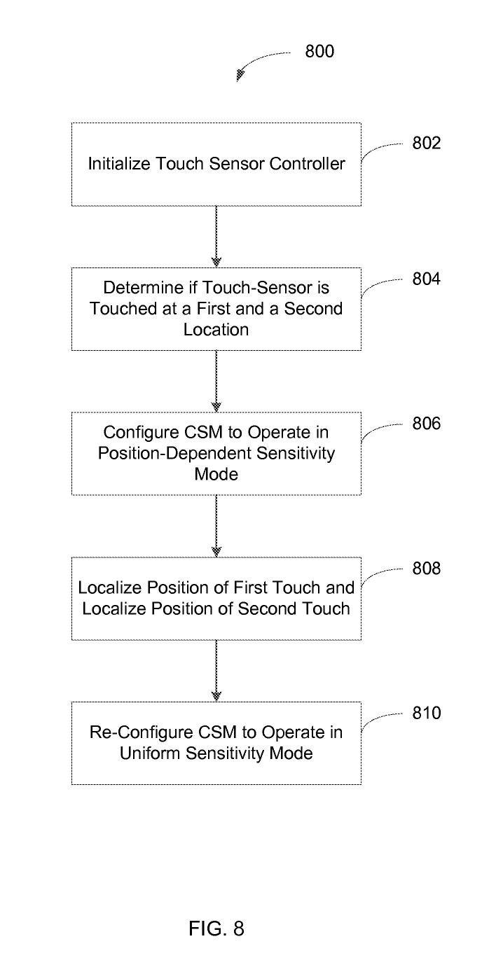

FIG. 8 is a flow diagram illustrating an exemplary method 800 for determining the position of a substantially simultaneous first and second touch (220 and 222 of FIG. 6 for example) of a self-capacitance touch sensor 202 (FIG. 2), for example. The method 800 may be implemented in the controller 500 (FIG. 5), in an embodiment. Functionality ascribed to the several steps of method 800 may implemented in hardware or software or any combination thereof. The term software as used herein corresponds to computer executable instructions that may be executed by processor 505 and microcontroller 512, in this embodiment.

At block 802, the controller 500 may be initialized. In an embodiment, processor 504 may initialize controller 500 in response to receiving an indication from host system 106. Initializing controller 500 may include processor 504 retrieving computer executable instructions stored in memory such as ROM 508. Processor 504 may copy the retrieved computer executable instructions to RAM 506. In an embodiment, microcode that may be executed by microcontroller 512 may be stored in ROM 508. In this embodiment, processor 504 may transfer the microcode to microcontroller 512. The microcode may include instructions that, when executed by microcontroller 512, may cause microcontroller 512 to measure the capacitance presented by the row and column electrodes. In an embodiment, processor 504 may program the clocks 518 and 520 with operating frequency values that cause the sigma-delta modulator 510 to operate in the previously described uniform sensitivity mode. In this embodiment, processor 504 may also retrieve from ROM 508 coefficients “m” and “c” for Equation 1.

At block 804, controller 500 may determine if touch sensor 202 was touched at a first and a second location. At block 804, controller 500 operates in the uniform sensitivity mode. In an embodiment, at block 804, processor 504 may instruct microcontroller 512 to scan the row electrodes 204-1 to 204-8 and the column electrodes 206-1 to 206-15. As previously discussed, scanning the electrodes comprises operating MUX 514 to sequentially connect the electrodes to the output 516 of MUX 514 and retrieving a count value of the counter 538 each time an electrode is connected to the output 516 of MUX 514. The count value produced is proportional to or representative of the capacitance presented by the electrode connected to the output 516 of MUX 514. Microcontroller 512 may transfer the count values produced during the scan to processor 504. The count values may be transferred via previously discussed scan buffers 602, 634 (FIG. 6).

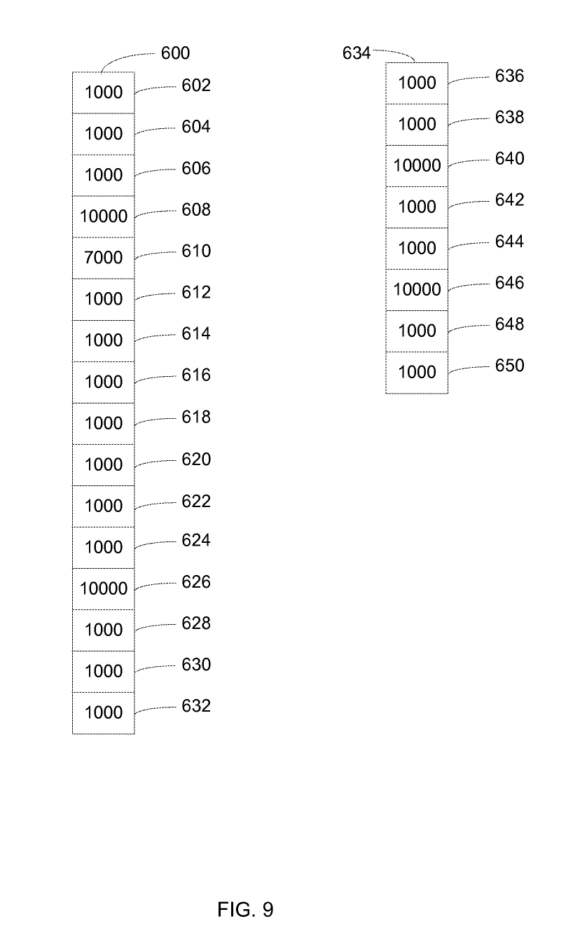

FIG. 9 illustrates exemplary data contained in scan buffer 602 and scan buffer 634. Data elements of scan buffer 602 contain count values representative of the capacitance presented by the corresponding column electrodes. Respective data elements of scan buffer 602 contain count values representative of the capacitance presented by the respective corresponding column electrodes. Similarly, respective data elements of scan buffer 634 contain count values representative of the capacitance presented by the respective corresponding row electrodes.

Processor 504 may analyze the data elements of scan buffer 602 and the data elements of scan buffer 634 to identify data elements where the count value exceeds a predefined threshold. A respective electrode corresponding to a respective data element whose count value exceeds the predefined threshold indicates that the electrode was touched. Based on count values of data element 608 and data element 626, processor 504 may identify that column electrode 206-4 (corresponding to data element 608) and column electrode 206-12 (corresponding to data element 628) were touched. Because two data elements corresponding to two spatially separated column electrodes exhibit count values that indicate a maximal deviation from the baseline count 1000, logical operations implemented by processor 504 may conclude that self-capacitance touch sensor 202 was touched at two locations. Similarly, based on count values of data elements 640 and 646 of scan buffer 634, processor 504 may identify that row electrode 204-3, corresponding to data element 640, and row electrode 204-6, corresponding to data element 640, were touched.

In response to determining that touch sensor 202 was touched at two locations i.e. a multi-touch, at block 806, processor 504 may configure capacitance sensing module 502 to operate in position-dependent sensitivity mode. As previously discussed, in the case of sigma-delta modulator 510, configuring capacitance sensing module 502 to operate in position-dependent sensitivity mode comprises programming the operating frequency of clocks 518 and 520 with values that cause the electrodes to exhibit position-dependent sensitivity.

At block 808, processor 504 may instruct microcontroller 512 to rescan the column electrodes and row electrodes while operating in position-dependent sensitivity mode. After scanning the row and column electrodes, microcontroller 512 may communicate scan buffers 602 and 634 to processor 504. As described with respect to FIG. 6, scan buffers 602 and 634 include data elements that contain the count values of counter 538 produced during the scan. Processor 504 may retrieve count values from data elements associated with electrodes that were identified as having been touched at step 804. As previously explained, processor 504 may utilize the coefficients of Equation 1 and the count value, example 640, for one of the identified row electrodes, for example electrode 204-3, to determine the location Y of the touch along that electrode. Based on the determined Y location, processor 504 may identify the column electrode closest to the location Y. Thus, processor 504 may determine the row and column of the position of the first touch. Similarly, processor 504 may utilize the coefficients of Equation 1 and the count value, example 646, for the other one of the identified row electrodes, example 204-4, to determine the location Y of the touch along that row electrode. Based on the determined Y location, processor 504 may identify the column electrode closest to the location Y. Thus, processor 504 may determine the row and column of the position of the second touch. At block 808, processor 504 may report back to host system 102 the respective identified row and column electrodes for the first and second touch, in an embodiment.

At block 810, processor 504 may reconfigure CSM 502 to operate in uniform sensitivity mode. After reconfiguring CSM 502, processor 504 may execute instructions that cause the program flow to branch to block 804 to detect another touch.

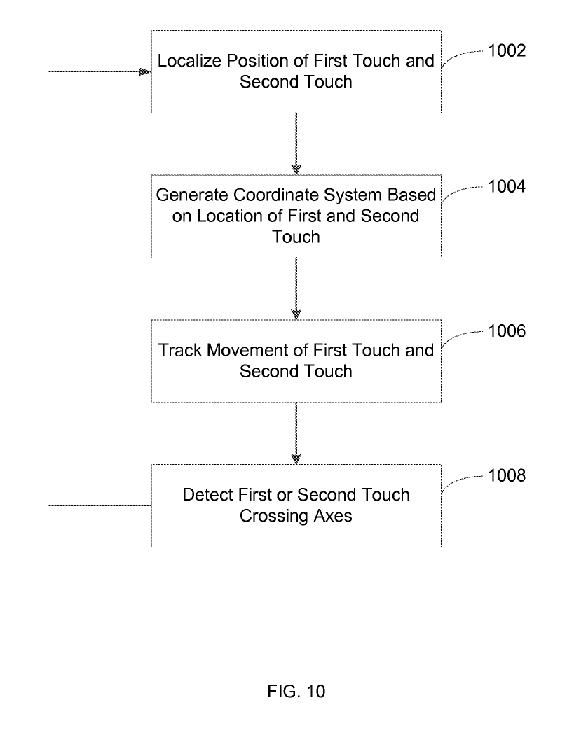

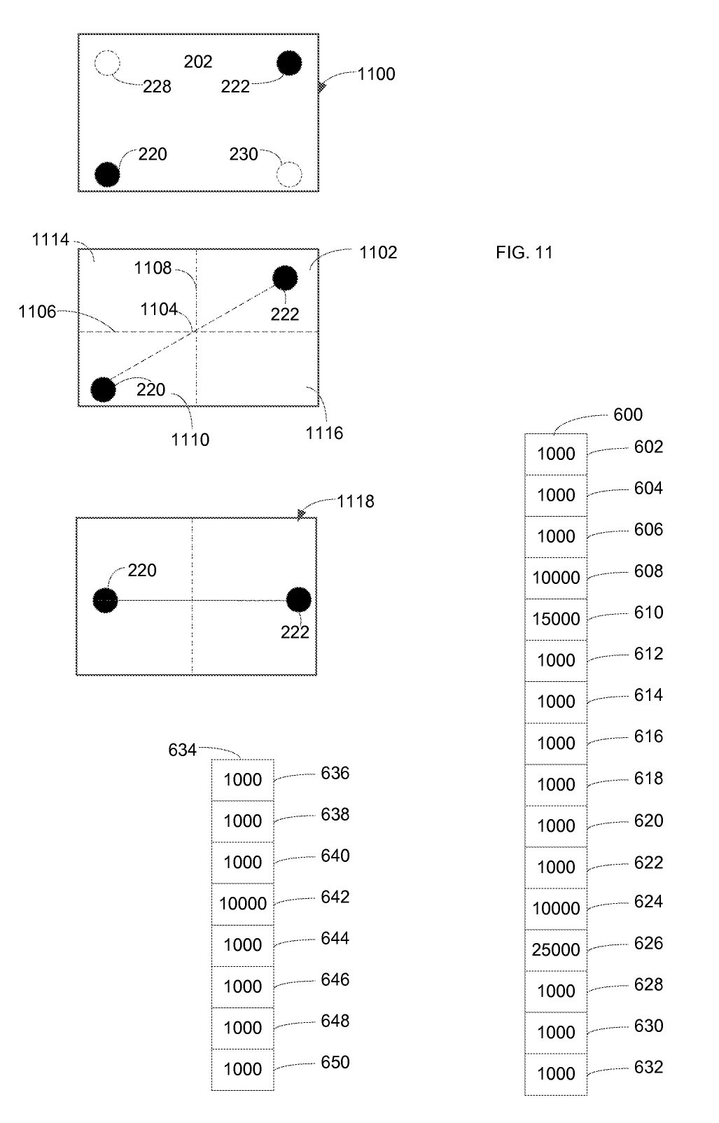

FIG. 10 is a flow diagram of an exemplary method 1000 that may be implemented by controller 500 to track a rotate gesture. In describing method 1000, reference is made to FIG. 11. FIG. 11 illustrates the discrete steps 1100, 1102 and 1118 of performing a multi-touch clockwise rotate gesture on the surface of self-capacitance sensor 202. Step 1100 of FIG. 11 depicts a first touch 220 and second touch 222 of self-capacitance touch-sensor 202. Step 1102 depicts the positions of the fingers in conjunction with a projected Cartesian coordinate system. Step 1118 depicts an intermediate step in performing the rotate gesture.

At block 1002 of FIG. 10, controller 500 may identify the row and column proximate to the respective position of the first touch 220 and second touch 222. The method steps of method 800 may be implemented at block 1002 to discriminate between the first touch 220 and second touch 222 and the ghost touches 228 and 230 described with reference to FIG. 4. At block 1002, controller 500 may report back the identity of the rows and columns.

At block 1004, controller 500 may determine the mid-point 1104, shown in FIG. 11, between the location of the first touch 220 and the second touch 222. Controller 500 may project a Cartesian coordinate system with the origin located at the mid-point 1104 and with horizontal axis 1106 and vertical axis 1108. Controller 500 may calculate coordinates for the first and second touch 220 and 222. Based on the calculated coordinates, at block 1004, controller 500 may associate the first touch 220 with the third quadrant 1110 of the coordinate system and the second touch 222 with the first quadrant 1112 of the coordinate system. Associating a touch to a quadrant may be referred to as tagging the touch. While determination of a mid-point is described, it should be recognized that the determined point need not be the exact center and that a certain amount of error will be tolerated. The illustration and description are meant to be illustrative only.

At block 1006, controller 500 may operate in uniform sensitivity mode to track the position of the first touch 220 and the second touch 222. Because controller 500 is operating in uniform sensitivity mode, controller 500 may not be able to discriminate between the ghost touches 228, 230 and the first touch 220 and the second touch 222, for reasons discussed with reference to FIG. 3.

In this embodiment, to perform the discrimination, controller 500 may calculate coordinates for the ghost touches 228 and 230. Based on the calculated coordinates, controller 500 may tag the ghost touch 228 with the second quadrant 1114 of the coordinate system and tag the ghost touch 230 with the fourth quadrant 1116 of the coordinate system. Controller 500 may disregard the ghost touches 228, 230 because their respective quadrant tags do not match with the quadrant tags determined for first touch 220 and second touch 222 at block 1004. Thus, controller 500 may track the first touch 220 and second touch 222 in uniform sensitivity mode. Controller 500 may periodically report back to host system 102 the identity of the rows and columns or the coordinates associated with the first touch 220 and second touch 222.

At block 1008, controller 500 may detect that either the first touch 220 or the second touch 222 is crossing either the horizontal axis 1106 or the vertical axis 1108. This axis crossing may be determined based on analyzing the count value of the counter 538 stored in scan buffers 600 and 634. The scan buffers 600 and 634 illustrated in FIG. 11 depict typical count values for the data elements when both first touch 220 and the second touch 222 cross the horizontal axes 1106, in scenario 1118. Based on the previously determined quadrant tags and count values for the column electrodes 206-4 to 206-11 stored in data elements 610 and 626 of scan buffer 600 controller 500 may determine that the first touch 220 and the second touch 222 are located at column electrodes 206-4 to 206-11, respectively. Separately, based on the count values for the row electrode 204-4 stored in data element 642 of scan buffer 634 controller 500 may determine that the first touch 220 and the second touch 222 are both located proximal to row electrodes 204-4. Based on this, controller 500 may conclude that the rotate gesture produced by first touch 220 and second touch 222 is crossing the horizontal axes. A similar method may be used to detect crossing of the vertical axes. In response to detecting an axes crossing, the method may return to block 1002 to re-establish the position of the first touch 220 and second touch 222 after the crossing of the axes.

From the foregoing, it can be seen that the present disclosure provides improvements in determining the location of a touch of a self-capacitance touch sensor such as a touch sensitive screen. By causing the electrodes of the self-capacitance touch sensor to exhibit position dependent sensitivity, a location of a single touch may be determined from the magnitude of the deviation of capacitance from the baseline capacitance of either a row or column electrode.

Additionally, where in the past it was not possible to determine a first location and a second location of two approximately simultaneous touches of a self-capacitance touch sensor, by implementing methods such as those described herein, the first and second location of the two approximately simultaneous touches may be determined. Also, multi-touch gestures performed on the surface of a self-capacitance touch sensor may be tracked by using methods described herein.

Each of the methods described herein may be encoded in a computer-readable storage medium (e.g., a computer memory), programmed within a device (e.g., one or more circuits or processors), or may be processed by a controller or a computer. If the processes are performed by software, the software may reside in a local or distributed memory resident to or interfaced to a storage device, a communication interface, or non-volatile or volatile memory in communication with a transmitter. The memory may include an ordered listing of executable instructions for implementing logic. Logic or any system element described may be implemented through optic circuitry, digital circuitry, through source code, through analog circuitry, or through an analog source, such as through an electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable storage medium,” “machine-readable medium,” “propagated-signal” medium, and/or “signal-bearing medium” may comprise a medium (e.g., a non-transitory medium) that stores, communicates, propagates, or transports software or data for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory, such as a Random Access Memory (RAM), a Read-Only Memory (ROM), an Erasable Programmable Read-Only Memory (EPROM or Flash memory), or an optical fiber. A machine-readable medium may also include a tangible medium, as the software may be electronically stored as an image or in another format (e.g., through an optical scan), then compiled, and/or interpreted or otherwise processed. The processed medium may then be stored in a computer and/or machine memory.

Further embodiments can be envisioned by one of ordinary skill in the art after reading the foregoing. In other embodiments, combinations or sub-combinations of the above disclosed invention can be advantageously made. The block diagrams of the architecture and flow diagrams are grouped for ease of understanding. However it should be understood that combinations of blocks, additions of new blocks, re-arrangement of blocks, and the like are contemplated in alternative embodiments of the present disclosure.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

The specification and drawings are, accordingly, to be regarded in an illustrative rather than a restrictive sense. It will, however, be evident that various modifications and changes may be made thereunto without departing from the broader spirit and scope of the invention as set forth in the claims.

We claim:

1. A method for determining a location of a first touch and a location of a second touch of a self-capacitance touch sensor, wherein the self-capacitance touch sensor comprises a first set of electrodes and a second set of electrodes, wherein the first set of electrodes are substantially perpendicular to the second set of electrodes and wherein each of the first set of electrodes and each of the second set of electrodes has a respective length, a respective proximal end and a respective distal end, the method comprising:
receiving from a capacitive sensing module coupled to the self-capacitance touch sensor a first set of values, each respective value of the first set of values corresponding to a respective electrode of the first set of electrodes and the second set of electrodes, and wherein a magnitude of the each respective value corresponds to capacitance associated with the respective electrode, and wherein each respective electrode is characterized by a respective baseline capacitance;
determining, based on the magnitudes of the respective values of the first set of values, that the self-capacitance touch sensor was touched by a first touch and a second touch;
identifying a first and second electrode from the first set of electrodes and identifying a first and second electrode from the second set of electrodes;
in response to determining that the self-capacitance touch screen was touched by a first touch and second touch, updating a configuration of the capacitive sensing module and causing the capacitive sensing module to measure the respective capacitances presented by the identified first electrode and second electrode of the first set;
receiving from the capacitive sensing module a second set of data, wherein the magnitude of respective data of the second set of data is proportional to the respective capacitance presented by the identified first electrode and second electrode of the first set and wherein the magnitude of the data corresponding to the first electrode is proportional to the distance of the first touch from the proximal or the distal end of the first electrode and the magnitude of the data corresponding to second electrode is proportional to the distance of the second touch from the proximal or the distal end of the second electrode;
based on the magnitude of the data corresponding to the first electrode, identifying the first electrode of the second set and, based on the magnitude of the data corresponding to the second electrode, identifying the second electrode of the second set; and
determining that the location of the first touch is proximal to the intersection of the first electrode of the first set and the first electrode of the second set and that the location of the second touch is proximal to the intersection of the second electrode of the first set and the second electrode of the second set.

2. The method of claim 1 wherein determining that the self-capacitance sensor was touched by the first touch and the second touch comprises determining at that least two values in the first set of values exceed a capacitance change threshold.

3. The method of claim 2 wherein determining that the self-capacitance sensor was touched by the first touch and the second touch comprises determining that the at least two values are separated by a third value that is below the capacitance change threshold.

4. The method of claim 1 wherein, before receiving the first set of values, the method comprises configuring the capacitive sensing module so that the first set of electrodes exhibit uniform sensitivity.

5. The method of claim 1 wherein updating the configuration of the capacitive sensing module comprises configuring the capacitive sensing module so that the first set of electrodes exhibit position dependent sensitivity.

6. The method of claim 5 wherein configuring the capacitive sensing module so that the first set of electrodes exhibit position dependent sensitivity comprises providing suitable control signals to the capacitive sensing module so that the respective capacitances presented by a respective electrode is characterized in that the magnitude of the capacitance change produced when the respective electrode is touched changes based on where along the length of the respective electrode the electrode is touched.

7. A touch enabled device comprising:
a self-capacitance touch screen comprising a set of row electrodes and a set of column electrodes wherein electrodes of the set of row electrodes are aligned substantially perpendicular to the set of row electrodes;
a capacitive sensing module electrically coupled with the self-capacitance touch screen; and
a touch detection module electrically coupled with the capacitive sensing module, wherein the touch detection module is configured to:
determine from a first set of scan data received from the capacitive sensing module that the self-capacitance touch sensor was touched by a first touch and substantially simultaneous second touch;
determine a respective identity of a first and second row electrode and a first and second column electrode proximate to the location of the first touch and the second touch;
configure a parameter in the capacitive sensing module in response to determining that the self-capacitance touch sensor was touched by the first touch and the substantially simultaneous second touch and cause the capacitive sensing module to measure respective capacitances presented by the identified first and second row electrode;
receive from the capacitive sensing module a second set of data, wherein the magnitude of respective data of the second set of data is proportional to the respective capacitance presented by the identified first and second row electrode and wherein the magnitude of the data corresponding to the first row electrode is proportional to the distance of the first touch from a proximal end or a distal end of the first row electrode and the magnitude of the data corresponding to second row electrode is proportional to the distance of the second touch from a proximal end or a distal end of the second row electrode;
determine, based on the magnitude of the data corresponding to the first row electrode, that the location of the first touch is proximal to the intersection of the first row electrode and the first column electrode and determine, based on the magnitude of the data corresponding to the second row electrode, that the location of the second touch is proximal to the intersection of the second row electrode and the second column electrode.

8. The touch enabled device of claim 7 wherein the touch detection module is initially configured in a uniform sensitivity mode suitable to detect any touch of the self-capacitance touch screen and, following configuration of the parameter, to operate in a position-dependent sensitivity mode suitable for determining where along the length a respective electrode between the proximal end of the respective electrode and the distal end of the respective electrode a touch is located.

9. The touch enabled device of claim 7 wherein the touch detection module is configured to identify respective rows and columns proximate to a respective position of the first touch and the respective position of a second touch of the self-capacitance touch screen, and to subsequently track movement of the respective position of the first touch and the respective position of the second touch.

10. The touch enabled device of claim 9 wherein the touch detection module is configured to tag touch data by associating a touch with a portion of the self-capacitance touch screen, to compare tagged touch data for the first touch and the second touch and to disregard ghost touches based on the comparison to accurately localize the first touch and the second touch on the self-capacitance touch screen.

11. A method for determining a position of a touch of one electrode of a set of electrodes of a self-capacitance touch screen, wherein each of the set of electrodes has a length, a proximal end and a distal end, the method comprising:
receiving, from a capacitive sensing module coupled with the self-capacitance touch screen, a first set of scan data, wherein the first scan data comprises values corresponding to the respective capacitances presented by each of the set of electrodes;
determining that the one electrode of the set of electrodes was touched by comparing each of the respective values with a threshold;
in response to determining that the one electrode of the set of electrodes was touched, updating a configuration of the capacitive sensing module;
receiving from the capacitive sensing module touch screen scan data wherein the received scan data has a value having a magnitude proportional to the capacitance presented by the one of the set of electrodes and wherein the magnitude of the scan data is proportional to the distance of the touch from the proximal end or the distal end of the one electrode of the set of electrodes; and
based on the magnitude of the scan data, determining a position of a touch of the one of a set of electrodes along the length of the one of a set of electrodes.

12. The method of claim 11 further comprising:
initially, operating in uniform sensitivity mode in which the first set of scan data comprises data has a value or magnitude which is proportional to the magnitude of the capacitances presented by each of the first set of electrodes; and
after updating the configuration of the capacitive sensing module, operating in a position-dependent sensitivity mode in which in which the received scan data has a value or magnitude which is proportional to the magnitude of the capacitance presented by the one of the set of electrodes and is also proportional to a distance along the length of one of the set of electrodes between the proximal end and the distal end of the one of the set of electrodes.

13. The method of claim 11 further comprising:
based on the first set of scan data, determining that the self-capacitance touch screen has been simultaneously touched by a first touch and a second touch;
determining position of the first touch and position of the second touch on the self-capacitance touch screen;
associating the first touch and the second touch with respective defined regions of the self-capacitance touch screen;
tracking positions of the first touch and the second touch as the first touch and the second touch move across the self-capacitance touch screen; and
when the tracked positions of the first touch and the second touch move outside the respective defined regions of the self-capacitance touch screen, re-establishing position of the first touch and the second touch.

14. The method of claim 13 wherein associating the first touch and the second touch with respective defined regions comprises:
operationally projecting a Cartesian coordinate system on at least a portion of the self-capacitance touch screen;
calculating coordinates for the first touch and the second touch;
associating the first touch with a first quadrant of the Cartesian coordinate system and associating the second couth with a third quadrant of the Cartesian coordinate system; and
when the tracked positions of one of the first touch and the second touch cross an axis of the Cartesian coordinate system, entering a position-dependent sensitivity mode to reliably determine current position of the first touch and the second touch.

15. The method of claim 14 further comprising:
calculating coordinates for respective ghost touches corresponding to the first touch and the second touch;
associating the respective ghost touches with a second quadrant and a fourth quadrant of the Cartesian coordinate system; and
subsequently, disregarding the respective ghost touches based on the associated quadrants while tracking positions of the first touch and the second touch.

16. The method of claim 11 further comprising:
initially, operating in uniform sensitivity mode to receive the first set of scan data;
based on the first set of scan data, determining that the self-capacitance touch screen has been simultaneously touched by a first touch and a second touch;
operating in a position-dependent sensitivity mode, determining position of the first touch and position of the second touch on the self-capacitance touch screen;
returning to the uniform sensitivity mode;
associating the first touch and the second touch with respective defined regions of the self-capacitance touch screen;
in the uniform sensitivity mode, tracking positions of the first touch and the second touch as the first touch and the second touch move across the self-capacitance touch screen; and
when the tracked positions of the first touch and the second touch move outside the respective defined regions of the self-capacitance touch screen, returning to the position-dependent sensitivity mode and re-establishing position of the first touch and the second touch.

17. A method for determining a position of a touch of a self-capacitance touch screen, the method comprising:
entering a uniform sensitivity mode of operation of a touch detection circuit which is electrically coupled with the self-capacitance touch screen;
receiving first scan data from two or more electrodes of the self-capacitance touch screen;
based on the received first scan data; determining that a touch of the self-capacitance touch screen has occurred;
entering a position-dependent sensitivity mode of operation of the touch decision circuit;
receiving second scan data from the two or more electrodes;
based on the second scan data, determining a position along a length of each electrode of the two or more electrodes, between a distal end and a proximal end of the each electrode, for the touch.

18. The method of claim 17 wherein entering a uniform sensitivity mode of operation comprises selecting control signals for the self-capacitance touch screen so that irrespective of the location of the touch of the self-capacitance touch screen, the magnitude of the received first scan data in response to the touch is approximately the same, and wherein entering a position-dependent sensitivity mode comprises selecting control signals for the self-capacitance touch screen so that the magnitude of the received second scan data varies based on the location of the touch of the touch-sensitive surface.

19. The method of claim 17 further comprising:
based on the first scan data, determining that a first touch and a second touch have occurred;
based on the second scan data, localizing the first touch and the second touch on the self-capacitance touch screen;
entering the uniform sensitivity mode to track movement of the first touch and the second touch across the self-capacitance touch screen; and
from time to time, entering the position dependent sensitivity mode to localize the first touch and the second touch on the self-capacitance touch screen.
